(19) United States
(12) Patent Application Publication
(10) Pub. No.: US 2021/0150381 A1
(43) Pub. Date: May 20, 2021

(54) CONTEXT BASED PREDICTION OF A COMMUNICATION TIME

(71) Applicant: International Business Machines Corporation, Armonk, NY (US)

(72) Inventors: OZNUR ALKAN, Dublin (IE); ADI I. BOTEA, Dublin (IE); Elizabeth Daly, Dublin (IE); AKIHIRO KISHIMOTO, Dublin (IE); RADU MARINESCU, Dublin (IE); Christian Muise, Somerville, MA (US)

(21) Appl. No.: 16/686,319

(22) Filed: Nov. 18, 2019

(51) Int. Cl. G06N 5/04; G06N 3/00

(52) U.S. Cl. CPC G06N 5/04; G06N 3/006

(57) ABSTRACT

Embodiments of the present invention provide methods, computer program products, and systems to receive information pertaining to one or more tasks. Embodiments of the present invention can be used to predict a communication time at which a user is available is based, at least in part, on position movements of the user, sentiment of the user, and urgency of a task in the one or more tasks. Embodiments of the present invention can be used to, in response to confirming user availability, select a task from the one or more tasks and initiating a communication event for the task at the predicted communication time.

### BACKGROUND

The present invention relates generally to the automated agents, and more particularly to virtual assistant interaction with users.

Virtual assistants are typically a software agent that can perform tasks or services for an individual based on input from a user. An input can typically be a command or questions from the user. Virtual assistants are sometimes referred to as a “chatbot”. In some cases, online chat programs are exclusively for entertainment purposes. Some virtual assistants are able to interpret human speech and respond via synthesized voices. Users can ask their assistants questions, control home automation devices and media playback via voice, and manage other basic tasks such as e-mail, to-do lists, and calendars with verbal commands. Capabilities of virtual assistants also extend to voice user interfaces (e.g., smart devices such as smart speakers, smart phones, tablets, etc.).

### SUMMARY

Embodiments of the present invention provide methods, computer program products, and systems to receive information pertaining to one or more tasks; predict a communication time at which a user is available is based, at least in part, on position movements of the user, sentiment of the user, and urgency of a task in the one or more tasks; and in response to confirming user availability, selecting a task from the one or more tasks and initiating a communication event for the task at the predicted communication time.

### BRIEF DESCRIPTION OF THE DRAWINGS

FIG. 1, is a functional block diagram illustration a computing environment, in accordance with an embodiment of the present invention;

FIG. 2 is a flowchart depicting operational steps for predicting an interaction time and executing communications at the predicted interaction time, in accordance with an embodiment of the present invention;

FIG. 3 is a flowchart depicting operational steps for predicting a communication time based on changes in position, in accordance with an embodiment of the present invention;

FIG. 4 is a flowchart depicting operational steps for predicting a communication time based on sentiment and urgency of a communication interaction, in accordance with an embodiment of the present invention; and

FIG. 5 depicts a block diagram of components of the computing systems of FIG. 1, in accordance with an embodiment of the present invention.

### DETAILED DESCRIPTION

Embodiments of the present invention recognize deficiencies of virtual assistant systems. Specifically, embodiments of the present invention recognize that traditional virtual assistant systems are typically triggered by events such as push notifications. Often times, push notifications are presented at the moment the notification containing information becomes available. In other circumstances, push notifications are presented at predetermined intervals and presented regardless of availability or convenience for a user. As such, embodiments of the present invention provide solutions for interaction events such as push notifications being displayed or otherwise initiated at inconvenient times. For example, embodiments of the present invention provide context based prediction for a communication time for a communication (e.g., interaction) events that virtual assistants can execute. Specifically, embodiments of the present invention can predict an interaction time to initiate an interaction based on movement and/or mood of a user as discussed in greater detail later in this Specification.

As used herein, an “interaction event” refers to an interaction between a virtual assistant and a user. In certain circumstances, an interaction event can be a communication to the user (e.g., a push notification. The communication can be text, including online chats (e.g., instant messaging), SMS text, e-mail, or other text-based communication channels. A communication can further include audio (such as voice) in circumstances when the virtual assistant is embedded as part of a smart device (e.g., smart speaker, tablet, smart phone). A communication can also include image based communication (e.g., by taking and/or uploading images).

An interaction event can include reminders that are triggered by user calendar events, weather reports. In certain other embodiments, an interaction event can be a query to the user requesting information. An interaction event can also include a request for user information. As used herein, “user information” refers to information associated with a user and can be found in a user's profile, user preferences, e-mail, to-do list, calendar, and in certain circumstances, the user's social media.

User information can further include position information of a user. Position information refers to directional information or changes in directional information that includes a user's location. Positional information can also include information surrounding an area of the user. Embodiments of the present invention provide mechanisms for a user to opt-in and opt-out of data collection events (e.g., user information) and can, in some instances, transmit a notification that user information is being collected or otherwise being accessed and used. Embodiments of the present invention provide an opt-in/opt-out mechanism for users to share and/or allow access to user information. In some embodiments, a notification can be transmitted to the user each time user information and/or position information of the user is being access or otherwise used.

In yet other embodiments, an interaction event can further include one or more actions performed by the virtual assistant. For example, in some cases, embodiments of the present invention can, in response to a user request alter a user's calendar by rescheduling an appointment (e.g., by contacting a party associated with the appointment, updating an appointment time, confirming the updated appointment).

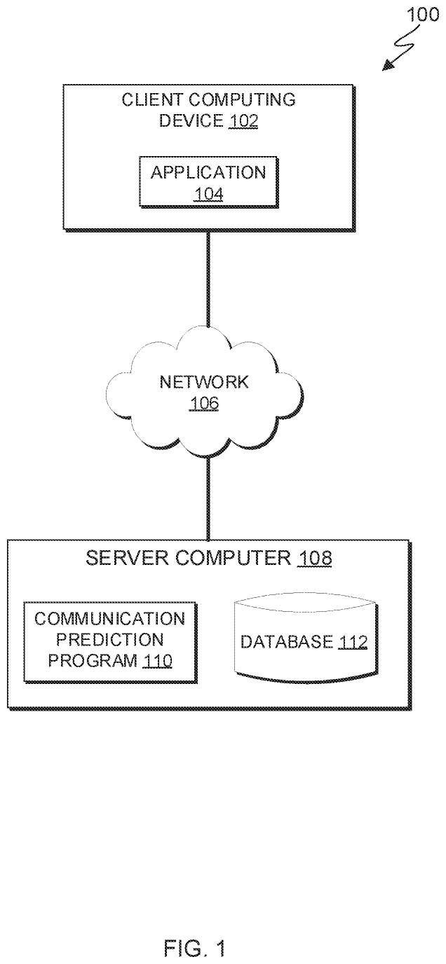

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

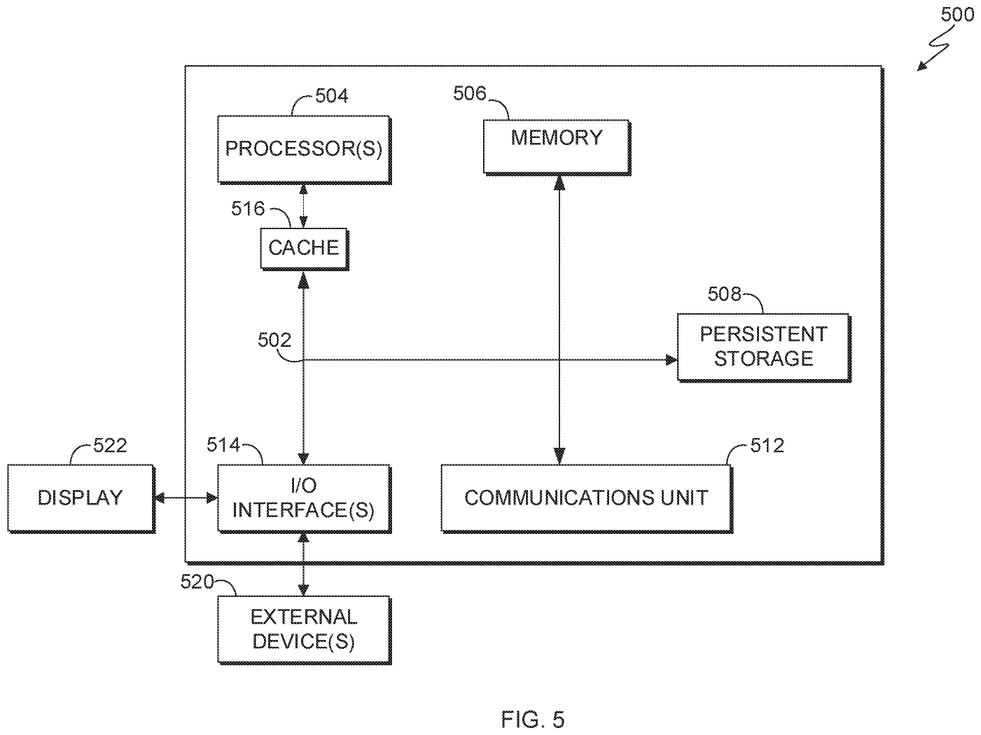

Computing environment 100 includes client computing device 102 and server computer 108, all interconnected over network 106. client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 5.

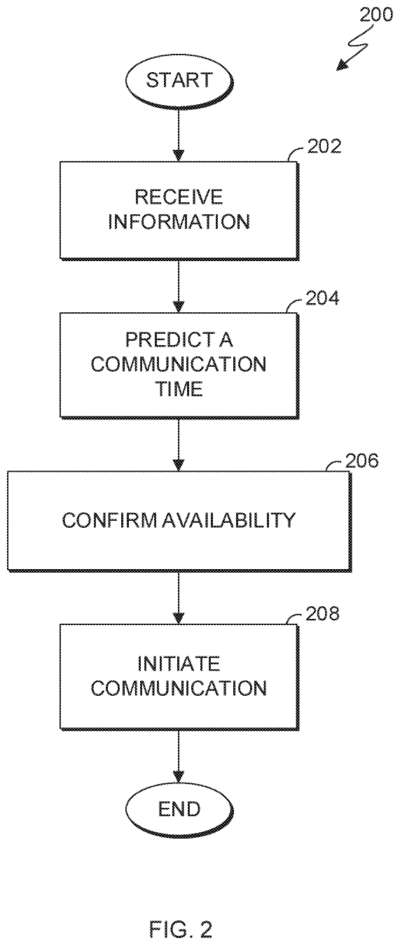

Client computing device 102 is a digital device associated with a user and includes application 104. Application 104 communicates with server computer 108 to access communication prediction program 110 (e.g., using TCP/IP) to access user information. Application 104 can further communicate with communication prediction program 110 to transmit instructions to predict a communication time when a user is available and initiate an interaction at the predicted communication time with regard to FIGS. 2-4. In some embodiments, application 104 can transmit user information (e.g., text-based, audio-based, image based information). In other embodiments, application 104 can transmit user preferences to communication prediction program 110. In general, application 104 can be implemented using a browser and web portal or any program that can interface with or otherwise access communication prediction program 110.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts communication prediction program 110 and database 112. In this embodiment, database 112 functions as a repository for stored content. Database 112 can reside on a cloud infrastructure and stores user generated information. In some embodiments, database 112 can function as a repository for one or more files containing user information.

As used mentioned earlier, “user information” refers to information associated with a user and can be found in a user's profile, user preferences, e-mail, to-do list, calendar, and in certain circumstances, the user's social media. User information can also refer to position information of the user. In this embodiment, database 112 is stored on server computer 108 however, database 112 can be stored on a combination of other computing devices (not shown) and/or one or more components of computing environment 100 (e.g., client computing device 102).

In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108. In other embodiments, database 112 can be stored on other computing devices (not shown) or can be a combination of one or more other databases that has given permission access to communication prediction program 110.

In this embodiment, communication prediction program 110 resides on server computer 108. In other embodiments, communication prediction program 110 can have an instance of the program (not shown) stored locally on client computing device 102. In yet other embodiments, communication prediction program can be stored on any number or computing devices (e.g., a smart device).

Communication prediction program 110 predicts a communication time and executing communications at the predicted communication time. In this embodiment, communication prediction program 110 predicts a communication time based on user availability, urgency of content associated with the interaction event, and whether the user is willing to interact with a virtual assistant.

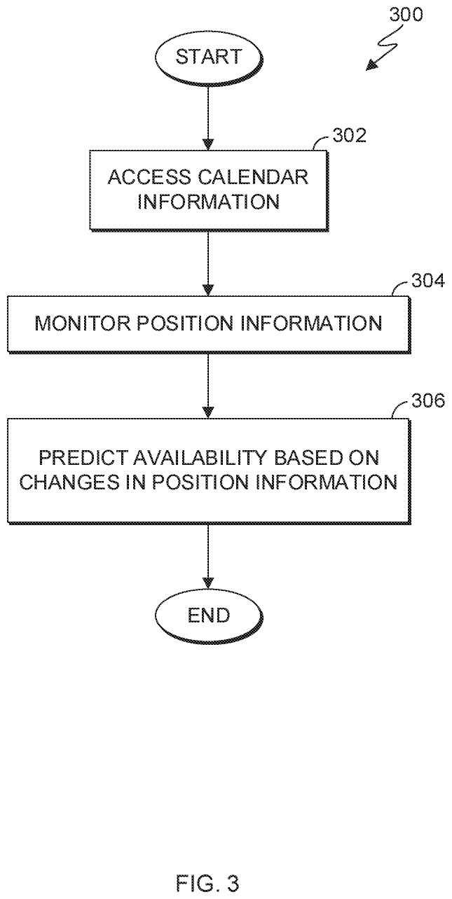

In this embodiment, communication prediction program 110 predicts an interaction time by determining whether the user is moving. Communication prediction program 110 determines whether a user is moving by accessing client computing device 102 and can leverage sensors on client computing device (e.g., accelerometer, GPS modules, etc.) as discussed in greater detail with regards to FIGS. 2 and 3.

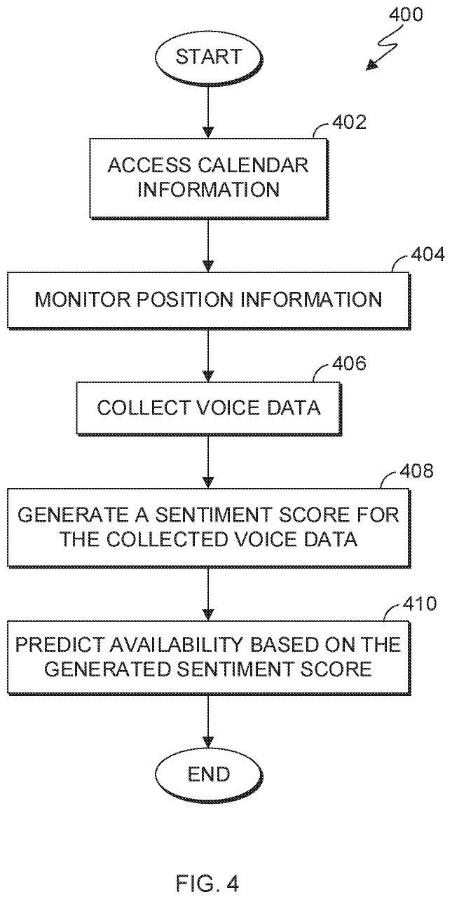

In this embodiment, communication prediction program 110 can also predict an interaction time by determining user sentiment and urgency of content associated with the communication event. In this embodiment, communication prediction program 110 determines user sentiment by generating a sentiment score for the user based on audio communications of the user from a measured time period at least thirty minutes prior to a schedule time the user is available as discussed in greater detail with respect to FIG. 4. In response to the sentiment analysis score reaching or exceeding a configurable threshold, communication prediction program 110 can identify that a user is willing to interact with the virtual assistant.

In certain circumstances, a user may not be willing to interact with the virtual assistant, however, communication prediction program 110 can still initiate and complete an interaction event based on urgency of content associated with the interaction event. Communication prediction program 110 can further refine its prediction based on urgency of content associated with the interaction event. In this embodiment, communication prediction program 110 utilizes a combination of natural language processing and artificial intelligence algorithms to determine context associated with an interaction event. Communication prediction program 110 can then generate an urgency score based on the determined context. For example, communication prediction program 110 identifies that a user is speaking on the phone with his or her parent and identify that the user is not willing to interact with the virtual assistant. Communication prediction program 110 can further identify that flight information (e.g., a gate change) for a user has changed fifteen minutes prior to the scheduled departure time as urgent (e.g., reaching or exceeding the urgency threshold). Communication prediction program 110 can then initiate an interaction event by communicating with the user (e.g., notifying the user of the flight information change).

In yet other embodiments, communication prediction program 110 can predict an interaction time based on data collected from other users that communication prediction program 110 identifies as being similar to the user. For example, communication prediction program 110 can predict an interaction time leveraging social media of the user to identify that user profiles that interact with the user (e.g., friends of the user) preferred an interaction event when a certain set of conditions occurred. Accordingly, communication prediction program 110 can wait to initiate an interaction event until the certain set of conditions occurred.

FIG. 2 is a flowchart 200 depicting operational steps for predicting an interaction time and executing communications at the predicted interaction time, in accordance with an embodiment of the present invention.

In step 202, communication prediction program 110 receives information. In this embodiment, communication prediction program 110 receives information by transmitting a request to client computing device 102 for information. Information received by communication prediction program 110 generally refers to user information that refers to details, and activities associated with a user and can be found in a user's profile, user preferences (routines, pre-defined responses to events, and other constraints), e-mail, to-do list, calendar, messaging services, and in certain circumstances, the user's social media. In certain other embodiments, items on a user's to-do list can include deadlines associated with scheduled events and similarly can include an urgency score associated with a scheduled event.

User information can further include position information of a user. As mentioned above, position information refers to directional information or changes in directional information that includes a user's location. Positional information can also include information surrounding an area of the user. Communication prediction program 110 can receive positioning information of a user by transmitting instructions to accelerometer and corresponding GPS modules embedded in client computing device 102.

In certain embodiments, communication prediction program 110 can be given permission access by a user to access user information directly from client computing device 102 at regular, pre-defined intervals. In other embodiments, user information can be sent from client computing device 102 to communication prediction program 110 at regular intervals. In circumstances where user information resides on multiple sources (e.g., multiple computing devices), communication prediction program 110 can invoke a merger module (not shown) to combine and de-duplicate duplicative user information.

In step 204, communication prediction program 110 predicts a communication time. time. In this embodiment, communication prediction program 110 predicts a communication time based on user availability, urgency of content associated with the interaction event, and whether the user is willing to interact with a virtual assistant.

For example, communication prediction program 110 predicts an interaction time by determining whether the user is moving. Communication prediction program 110 determines whether a user is moving by accessing client computing device 102 and can leverage sensors on client computing device (e.g., accelerometer, GPS modules, etc.). In response to communication prediction program 110 determining that the position of the user has not changed in a given time period (e.g., a specified time frame), communication prediction program 110 determines that the user is available, as discussed in greater detail with regards to FIG. 3.

In this embodiment, communication prediction program 110 can also predict an interaction time by determining user sentiment and urgency of content associated with the communication event. In this embodiment, communication prediction program 110 determines user sentiment by generating a sentiment score for the user based on audio communications of the user from a measured time period at least thirty minutes prior to a schedule time the user is available as discussed in greater detail with respect to FIG. 4. In response to the sentiment analysis score reaching or exceeding a configurable threshold, communication prediction program 110 can identify that a user is willing to interact with the virtual assistant.

In certain circumstances, communication prediction program 110 can generate and otherwise utilize an urgency score to prioritize an interaction event and its' associated content regardless of user the predicted communication time and availability of the user. In these circumstances, communication prediction program 110 can initiate and complete an interaction event based on urgency of content associated with the interaction event, as discussed in greater detail with regard to FIG. 4.

In step 206, communication prediction program 110 confirms availability of a user. In this embodiment, communication prediction program 110 confirms availability of a user by monitoring changes to the user's position in a time interval prior to and immediately after the predicted communication time (e.g., within five minutes before and/or five minutes after the predicted communication time).

In this embodiment, communication prediction program 110 can also confirm availability of the user based on a detected mood of the user. For example, communication prediction program 110 can monitor or otherwise access audio from client computing device 102 at a time interval (e.g., thirty minutes) prior to the predicted communication time. Communication prediction program 110 can also access user information during the time interview prior to the predicted communication time (e.g., social media or messaging posts) and utilize a combination of natural language processing, machine learning, and artificial intelligence algorithms to determine a user's mood.

In this embodiment a user's mood is classified as either being positive or negative. A positive mood can be measured using biometrics, facial recognition features, and sentiment analysis and is associated with a willingness to participate in virtual assistant communications. Conversely, a negative mood is associated with an unwillingness to participate in virtual assistant communications.

In step 208, communication prediction program 110 initiates communication. In this embodiment, communication prediction program 110 initiates communication by selecting content to present the user. As used herein, “content” refers to information that is presented to the user. The information can include an item from the user's to-do list, a reminder for a scheduled, calendar event, a message from a service (e.g., push notification), etc. The content can be text, including online chats (e.g., instant messaging), SMS text, e-mail, or other text-based communication channels. A communication can further include audio (such as voice) in circumstances when the virtual assistant is embedded as part of a smart device (e.g., smart speaker, tablet, smart phone). A communication can also include image based communication (e.g., by taking and/or uploading images).

In this embodiment, communication prediction program 110 selects content to present the user based in a chronological order. For example, where there are three agenda items on a user's calendar, scheduled at 9:00 am, 10:00 am, and 11:00 am respectively, communication prediction program 110 can initiate communication (e.g., an interaction event) at the predicted communication time (e.g., at 8:50 am) and present the user with a reminder.

In this embodiment, communication prediction program 110 can reprioritize the chronological order of content based on urgency of content (e.g., based on an urgency score) associated with the communication (e.g., interaction event). For example, communication prediction program 110 can predict a communication time of 9:00 am but then detects the user would be either unavailable or in a negative mood (e.g., due to a negative mood detection based on a call the user had thirty minutes prior), communication prediction program 110 can then, based on an generated or otherwise detected urgency of the content (e.g., non-urgent) associated with the communication, iteratively revise the communication prediction time and confirm user availability. In response to the communication prediction program 110 confirming availability, communication prediction program 110 can then initiate the interaction event at the later predicted communication time to communicate a push notification (e.g., a push notification regarding the user's sport team).

FIG. 3 is a flowchart 300 depicting operational steps operational steps for predicting a communication time based on changes in position, in accordance with an embodiment of the present invention.

In step 302, communication prediction program 110 accesses calendar information. In this embodiment, communication prediction program 110 access calendar information by transmitting a request to client computing device 102 to send calendar information. In other embodiments, communication prediction program 110 can access calendar information from one or more other sources. In yet other embodiments, communication prediction program 110 can further access other user information pertaining to a schedule, to-do list, agenda items, etc. from any number and combination of sources pursuant to having permission access from the user.

In step 304, communication prediction program 110 monitors position information. In this embodiment, monitors position information by accessing sensors on client computing device 102 (e.g., accelerometers, GPS modules, etc.). Communication program 110 can then determine whether a user is moving by identifying changes in position of the user as defined by sensors on client computing device 102.

In step 306, communication prediction program 110 predicts user availability based on changes in position information. In this embodiment, communication prediction program 110 identifies a current time interval within a time period. For example, communication prediction program 110 can utilize a current time period defined by normal working business hours (9:00 am to 5:00 pm) and identify a current time within that period. Communication program 110 can then transmit program instructions to sensors of client computing device 102 (e.g., accelerometers, GPS modules, etc.) to send position information to communication prediction program 110.

Communication prediction program 110 can identify a current time in which the user is scheduled to be free (t). In this embodiment, communication prediction program 110 can monitor a time period defined by (t) plus a constant interval (e). The constant interval (e) can be a configurable interval (e.g., every minute). Communication program 110 can then correlate position information received form client computing device 102 to each monitored time period. In this manner, communication program 110 can identify changes in user position from a sequence of GPS positions received from client computing device 102.

If, communication prediction program 110 determines there is a change in position during the monitored time interval, communication prediction program 110 identifies that the user is not available. If communication prediction program 110 determines there is a change in position during the monitored time interval, then communication prediction program 110 confirms that the user is available.

FIG. 4 is a flowchart 400 depicting operational steps for predicting a communication time based on sentiment and urgency of a communication interaction, in accordance with an embodiment of the present invention.

In step 402, communication prediction program 110 accesses calendar information. In this embodiment, communication prediction program 110 access calendar information by transmitting a request to client computing device 102 to send calendar information. In other embodiments, communication prediction program 110 can access calendar information from one or more other sources. In yet other embodiments, communication prediction program 110 can further access other user information pertaining to a schedule, to-do list, agenda items, etc. from any number and combination of sources pursuant to having permission access from the user (e.g., data from one or more other components of FIG. 1).

In step 404, communication prediction program 110 monitors position information. In this embodiment, monitors position information by accessing sensors on client computing device 102 (e.g., accelerometers, GPS modules, etc.) as previously described in step 304, of flowchart 300. Communication program 110 can then determine whether a user is moving by identifying changes in position of the user as defined by sensors on client computing device 102. Accordingly, communication prediction program 110 predicts user availability based on changes in position information (as discussed in flowchart 300).

In step 406, communication prediction program 110 collects voice data. In this embodiment, communication prediction program 110 collects voice data during a time period defined by a current time (t) minutes minus a constant interval (e). The constant interval (e) for voice data collection can be a configurable interval (e.g., every thirty minutes). In other embodiments, communication prediction program 110 can correlate the collected voice data and the corresponding time periods associated with the voice data to collected position information using a merger module.

In step 408, communication prediction program 110 generates a sentiment score for the collected voice data. In this embodiment, communication prediction program 110 generates a sentiment score utilizing a combination of natural language processing, machine learning, and artificial intelligence algorithms to determine a user's mood. As mentioned above, a user's mood is classified as either being positive or negative with a positive mood indicating a willingness to participate in virtual assistant communications. Conversely, a negative mood is associated with an unwillingness to participate in virtual assistant communications.

In this embodiment, communication prediction program 110 utilizes a numeric scale where lesser numbers indicate lower scores and greater numbers indicate higher score (e.g., a sentiment score of 90 on a scale of 0-100 would indicate a high score and accordingly communication prediction program 110 would identify the score to indicate the user is available, that is willing to interaction with the virtual assistant). In this embodiment, a sentiment score threshold of fifty is used. In other embodiments, the sentiment score threshold can be configured to any number deemed suitable for the user.

In another embodiment, communication prediction program 110 can generate a sentiment score for a user using information other than collected voice data. Communication prediction program 110 can also access other user information during the time interval prior to the predicted communication time (e.g., social media or messaging posts) and use the other user information in combination with the collected voice data to generate a sentiment score. For example, communication prediction program 110 can identify a series of social media posts having quotes that are associated with sadness. Communication prediction program 110 can assign a lesser weight value for each social media post having the quotes associated with sadness than social media posts that do not have quotes associated with sadness. Communication prediction program 110 can then sum the social media scores.

In step 410, communication prediction program 110 predicts availability based on the generated sentiment score. In this embodiment, communication prediction program 110 predicts availability of a user based on the generated sentiment score. In response to the sentiment scores for the series of social media posts not reaching or exceeding the sentiment threshold, communication prediction program 110 can identify that the user as being either available or not available to communicate with the virtual assistant. For example, communication prediction program 110 can assign weight values to portions of the collected voice datand sum the assigned weight values. In response to the sentiment scores for the series of social media posts not reaching or exceeding the sentiment threshold, communication prediction program 110 can identify that the user as being unwilling to communicate with the virtual assistant.

Communication prediction program 110 can further refine its prediction by utilizing an urgency score for a corresponding communication or interaction event. For example, communication prediction program 110 can also access urgency scores associated with a scheduled event or item on a user's to do list. In instances where no urgency score is associated with a communication event (e.g., an item on the user's to do list or scheduled event), communication prediction program 110 assigns it a “low” or non-urgent urgency score. In other embodiments, communication prediction program 110 can generate an urgency score for the communication event based on contextual information using a combination of natural language processing techniques, machine learning techniques, and artificial intelligence algorithms.

In this embodiment, communication prediction program 110 utilizes a numeric scale where lesser numbers indicate lower probabilities and greater numbers indicate higher probabilities (e.g., an urgency score of 10 on a scale of 0-100 would indicate a low score and thus a be designated as non-urgent). In this embodiment, an urgency score threshold of fifty is used. In other embodiments, the sentiment score threshold can be configured to any number deemed suitable for the user.

In circumstances where communication prediction program 110 has access to both scheduled events and/or items on a user's to do list, and accompanying urgency scores, communication prediction program 110 determines a user is available when the threshold scores for the user's sentiment (e.g., mood) and urgency of the associated communication content are reached or exceeded (e.g., when the user's mood is positive regardless of urgency).

In certain embodiments, communication prediction program 110 can confirm whether or a user is available based on the user's preference. For example, despite the user's mood being positive (e.g., indicating the user is available), the user may not want to interact (e.g., unwilling) with a virtual assistant because the user is otherwise occupied (e.g., reading e-mail). In these circumstances, communication prediction program 110 can reference either the user's preference or infer a user's willingness or unwillingness to communicate with the virtual assistant based on a contextual analysis to determine whether the user is occupied. As used herein, a user is designated as “occupied” if the user is otherwise engaged in another activity (e.g., reading an email, on a phone call, talking with another person, watching a video, reading, etc.).

In this embodiment, where the user's mood is negative (e.g., does not reach or exceed the sentiment score threshold) but the communication event is urgent (e.g., reaches or exceeds the urgency threshold, (e.g., the communication event is designated as “high”), communication prediction program 110 determines the user is available.

In this embodiment, where the user's mood is negative (e.g., does not reach or exceed the sentiment score threshold) and the communication is non urgent (e.g., does not reach or exceed the urgency threshold (e.g., the communication event is designated as “low”)), communication prediction program 110 determines the user is not available.

In embodiments where an urgency score is not available, communication prediction program 110 can generate an urgency score based on contextual information associated with an interaction event (e.g., an item on a user's to do list, scheduled events of a user's calendar and associated information). For example, communication prediction program 110 can use natural language processing and machine learning techniques to parse text and identify words that are associated with either positive or negative moods. In circumstances where a word neither has positive or negative associates, communication prediction program 110 assigns a neutral weight value (e.g., 0) to the word. Communication prediction program 110 can then sum the values and in response to reaching or exceeding the urgency score threshold, communication prediction program 110 can identify a communication (e.g., interaction) event as urgent.

FIG. 5 depicts a block diagram of components of computing systems within computing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 510, and input/output (I/O) interface(s) 512. Communications fabric 502 can be implemented with any architecture designed for passing datand/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Communication prediction program 110 (not shown) may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Communication prediction program 110 may be downloaded to persistent storage 508 through communications unit 510.

I/O interface(s) 512 allows for input and output of data with other devices that may be connected to client computing device and/or server computer 108. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., communication prediction program 110, can be stored on such portable computer readable storage mediand can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving information pertaining to one or more tasks;
predicting a communication time at which a user is available is based, at least in part, on position movements of the user, sentiment of the user, and urgency of a task in the one or more tasks; and
in response to confirming user availability, selecting a task from the one or more tasks and initiating a communication event for the selected task at the predicted communication time.

2. The computer-implemented method of claim 1, wherein predicting a communication time at which a user is available comprises:
accessing calendar information of the user;
monitoring position information of the user during a specified time frame; and
predicting availability of the user based on changes in position information of the user.

3. The computer-implemented method of claim 1, wherein predicting a communication time at which a user is available comprises:
accessing calendar information of the user;
monitoring position information of the user during a specified time frame;
collecting voice data during the specified time frame;
generating a sentiment score for the collected voice data; and
predicting availability of the user based on the generated sentiment score.

4. The computer-implemented method of claim 3, further comprising:
refining the predicted availability of the user based on respective urgency scores of each task in the one or more tasks.

5. The computer-implemented method of claim 4, wherein refining the predicted availability of the user based on respective urgency scores of each tasks in the one or more tasks comprises:
identifying that the generated sentiment score does not reach or exceeds a sentiment score threshold that indicates a user as being available;
in response to identifying that the generated sentiment score does not reach or exceeds a sentiment score threshold that indicates a user as being available, determining whether or not the task is urgent or not urgent; and
in response to determining that the task is urgent, identifying that the user is available.

6. The computer-implemented method of claim 4, wherein refining the predicted availability of the user based on respective urgency scores of each tasks in the one or more tasks comprises:
identifying that the generated sentiment score reaches or exceeds a sentiment score threshold that indicates a user as being available;
in response to identifying that the generated sentiment score reaches or exceeds a sentiment score threshold that indicates a user as being available, determining whether or not the task is urgent or not urgent; and
in response to determining that the task is not urgent, determining whether the user occupied based on contextual information; and
in response to determining that the user is occupied, identifying that the user is unavailable.

7. The computer-implemented method of claim 3, wherein predicting availability of the user based on the generated sentiment score comprises:
in response to summed weight values of collected voice data reaching or exceeding a sentiment score threshold indicating a positive user mood, identifying the user as being available.

8. A computer program product comprising:
one or more computer readable storage mediand program instructions stored on the one or more computer readable storage media, the program instructions comprising:
program instructions to receive information pertaining to one or more tasks;
program instructions to predict a communication time at which a user is available is based, at least in part, on position movements of the user, sentiment of the user, and urgency of a task in the one or more tasks; and
program instructions to, in response to confirming user availability, select a task from the one or more tasks and initiating a communication event for the selected task at the predicted communication time.

9. The computer program product of claim 8, wherein the program instructions to predict a communication time at which a user is available comprise:
program instructions to access calendar information of the user;
program instructions to monitor position information of the user during a specified time frame; and
program instructions to predict availability of the user based on changes in position information of the user.

10. The computer program product of claim 8, wherein the program instructions to predict a communication time at which a user is available comprise:
program instructions to access calendar information of the user;
program instructions to monitor position information of the user during a specified time frame;
program instructions to collecting voice data during the specified time frame;
program instructions to generate a sentiment score for the collected voice data; and
program instructions to predict availability of the user based on the generated sentiment score.

11. The computer program product of claim 10, wherein the program instructions stored on the one or more computer readable storage media further comprise:
program instructions to refining the predicted availability of the user based on respective urgency scores of each task in the one or more tasks.

12. The computer program product of claim 11, wherein the program instructions to refine the predicted availability of the user based on respective urgency scores of each tasks in the one or more tasks comprise:
program instructions to identify that the generated sentiment score does not reach or exceeds a sentiment score threshold that indicates a user as being available;
program instructions to, in response to identifying that the generated sentiment score does not reach or exceeds a sentiment score threshold that indicates a user as being available, determine whether or not the task is urgent or not urgent; and
program instructions to, in response to determining that the task is urgent, identify that the user is available.

13. The computer program product of claim 11, wherein the program instructions to refine the predicted availability of the user based on respective urgency scores of each tasks in the one or more tasks comprise:
program instructions to identify that the generated sentiment score reaches or exceeds a sentiment score threshold that indicates a user as being available;
program instructions to, in response to identifying that the generated sentiment score reaches or exceeds a sentiment score threshold that indicates a user as being available, determine whether or not the task is urgent or not urgent; and
program instructions to, in response to determining that the task is not urgent, determine whether the user occupied based on contextual information; and
program instructions to, in response to determining that the user is occupied, identify that the user is unavailable.

14. The computer program product of claim 10, wherein the program instructions to predict availability of the user based on the generated sentiment score comprise:
program instructions to, in response to summed weight values of collected voice data reaching or exceeding a sentiment score threshold indicating a positive user mood, identify the user as being available.

15. A computer system comprising:
one or more computer processors;
one or more computer readable storage media; and
program instructions stored on the one or more computer readable storage media for execution by at least one of the one or more computer processors, the program instructions comprising:
program instructions to receive information pertaining to one or more tasks;
program instructions to predict a communication time at which a user is available is based, at least in part, on position movements of the user, sentiment of the user, and urgency of a task in the one or more tasks; and
program instructions to, in response to confirming user availability, select a task from the one or more tasks and initiating a communication event for the selected task at the predicted communication time.

16. The computer system of claim 15, wherein the program instructions to predict a communication time at which a user is available comprise:
program instructions to access calendar information of the user;
program instructions to monitor position information of the user during a specified time frame; and
program instructions to predict availability of the user based on changes in position information of the user.

17. The computer system of claim 15, wherein the program instructions to predict a communication time at which a user is available comprise:
program instructions to access calendar information of the user;
program instructions to monitor position information of the user during a specified time frame;
program instructions to collecting voice data during the specified time frame;
program instructions to generate a sentiment score for the collected voice data; and
program instructions to predict availability of the user based on the generated sentiment score.

18. The computer system of claim 17, wherein the program instructions stored on the one or more computer readable storage media further comprise:
program instructions to refining the predicted availability of the user based on respective urgency scores of each task in the one or more tasks.

19. The computer system of claim 18, wherein the program instructions to refine the predicted availability of the user based on respective urgency scores of each tasks in the one or more tasks comprise:
program instructions to identify that the generated sentiment score does not reach or exceeds a sentiment score threshold that indicates a user as being available;
program instructions to, in response to identifying that the generated sentiment score does not reach or exceeds a sentiment score threshold that indicates a user as being available, determine whether or not the task is urgent or not urgent; and
program instructions to, in response to determining that the task is urgent, identify that the user is available.

20. The computer system of claim 18, wherein the program instructions to refine the predicted availability of the user based on respective urgency scores of each tasks in the one or more tasks comprise:
program instructions to identify that the generated sentiment score reaches or exceeds a sentiment score threshold that indicates a user as being available;
program instructions to, in response to identifying that the generated sentiment score reaches or exceeds a sentiment score threshold that indicates a user as being available, determine whether or not the task is urgent or not urgent; and
program instructions to, in response to determining that the task is not urgent, determine whether the user occupied based on contextual information; and
program instructions to, in response to determining that the user is occupied, identify that the user is unavailable.
